(19) United States
(12) Patent Application Publication
(10) Pub. No.: US 2025/0165201 A1
(43) Pub. Date: May 22, 2025

(54) Communal connecting media system

(71) Applicant: Maria Antonia Perez-Andujar, Kansas City, MO (US)

(72) Inventor: Maria Antonia Perez-Andujar, Kansas City, MO (US)

(21) Appl. No.: 18/892,203

(22) Filed: Sep. 20, 2024

Related U.S. Application Data
(60) Provisional application No. 63/539,418, filed on Sep. 20, 2023.

(51) Int. Cl. G06F 3/14

(52) U.S. Cl. CPC G06F 3/14

(57) ABSTRACT

A communal connecting media system that integrates visual display monitors mounted within a vertical support structure that has wire mesh for attaching love padlocks to.

This non-provisional application claims the benefit of provisional application No. 63/539,418 filed Sep. 20, 2023.

### FIELD OF THE INVENTION

The present invention generally relates to systems for promoting expression and social connectivity, and it is specifically directed to a system having public display apparatus configured to publicly display digital media content and tangible items that are, typically, person's expressions of affection, commitment, and social togetherness, and to display media content that promotes social togetherness by way of participation in group activities. The invention is further directed to such a system in which inhabitable structures (e.g., small houses) erected in proximity to the public display apparatus are integrated into the system in that the display apparatus functions as a common use media center for the enjoyment of occupiers of those structures.

### BACKGROUND OF THE INVENTION

Inscribing persons' names and personal messages onto padlocks that are to be attached to wire fencing or other fixtures to symbolize that named persons share an enduring love or other emotional commitment is a custom that is understood to have begun in early 20th century Europe, and the practice of publicly displaying these so called “love locks” gained much wider popularity, there, in the early 21st century.

Unfortunately, despite the positive sentiments that motivate most love lock creators to affix their personally inscribed padlocks to fixtures in open view, the sprawling accumulations of these padlocks that manifest in some public spaces can become viewed negatively, by some observers, as more eyesores than artistry. In fact, it is well understood that a love lock site which may have sprung out of the spontaneous decision of one person to attach a padlock to randomly located fence might not always engender the loving feeling that that person and subsequent ones who acted in kind to contribute to the love lock site's development did so with. Consequently, there is a recognized desire that love lock sites be planned in designated areas, rather than develop randomly.

The present inventor recognizes a further need concerning love lock sites, and she recognizes that love lock sites have the potential to facilitate more profound interpersonal engagement between its user-contributors. That is, the present inventor observes that in addition to permanently displaying love expression padlocks, a new love lock mounting structure can be configured in the form of an aesthetic, architectural structure that is equipped with digital monitors for more temporarily displaying what may be similar sentiments of love and personal connection in the form of user-submitted media content (i.e., photos and video). Even further, the present inventor observes that while such a communal structure for hosting such personal expressions is suited for public land venues, it also may be well-suited to be a common use feature of a planned residential development in the vein of the typical neighborhood swimming pool or clubhouse. The present invention fulfills these needs.

### SUMMARY OF THE INVENTION

It is an object of a first embodiment of the present invention to provide a structure that serves as a host structure for publicly displaying love and affection-themed both padlocks and media (i.e., text and imagery) for passersby to view and draw senses of personal and communal connection from.

In one aspect of this embodiment, a support structure of some configuration—preferably, of an architecturally aesthetic one—is provided for both elevating multiple, divergent-facing display monitors and supporting wire mesh. The purpose of those elevated monitors is to display text and images that may be electronically submitted to a host media system by people who, typically, are within or planning to come within viewing distance of the present structure so that they, others accompanying them, and anyone else appearing within the vicinity of this embodiment of the inventive structure can witness presentation of those submissions on the monitors. The present inventor anticipates that these textual and image submissions will usually be affectionate in nature.

Similarly, the purpose of the wire mesh is to provide a fixture to which visitors may secure love padlocks—objects that are well-known to serve as expressions of love and personal commitment. The present inventor further anticipates that observers of the structure will draw senses of personal and communal connection from the cornucopia of affectionate messaging and symbolism projecting from its monitor and mesh elements.

In another aspect of the first embodiment of the invention, a receiver and computing system operates to receive media submitted by what may be both visitors of the structure site and persons who are located entirely remotely from it and systematically display at least some of those submissions on the monitors.

Finally, in yet another aspect of this embodiment, the computing system is programmed to identify which of the submitted media is acceptable for public display on the monitors and which is not (e.g., contains profanity, obscenity, physical threat, incitement to violence, etc.), and it is further programmed to sequence delivery of the deemed displayable media to the monitors according to some defined priority logic. For example, [acceptable] submissions could be displayed on the monitors simply in the chronological order that they were received by the receiver, or they could be sequenced on some entirely different basis.

It is an object of a second embodiment of the present invention to provide a media system and structure that is physically situated in relation to multiple residential dwellings such that, irrespective of whether the inventive structure is configured to have love locks affixed to it as previously described, it functions as a common use amenity of a defined residential development in a similar vein to a neighborhood private swimming pool or private clubhouse. That is, a structure monitor(s) can be viewed from within each adjacent dwelling. And while the computing system used in this embodiment can certainly operate to receive user-submitted media for display on its monitors as contemplated for the first referenced embodiment, the present inventor anticipates that its display monitors will be used, primarily, to broadcast various types of programming for dwelling occupants to consume together. For example, yoga programming could be displayed for any of the neighbors to observe and to practice, themselves, if they so desired. For another example, a motion picture could be broadcasted on the monitors to simulate a “drive-in” movie-like experience within the residential neighborhood.

It is another object of this embodiment of the invention to provide transmitters—by way of either simply assigning them to persons associated with each dwelling that surrounds the present structure and/or physically integrating them into each dwelling—that enable media (e.g., video) to be submitted for display on the common area structure's monitors.

### BRIEF DESCRIPTION OF THE DRAWINGS

FIG. 1 is an elevational view of a media structure of the present invention;

FIG. 2 is another elevational view of the same; and

FIG. 3 is an elevational view of a media structure of the present invention-one in which multiple display housings are mounted atop the support structure.

### DETAILED DESCRIPTION OF THE PREFERRED EMBODIMENTS

The present disclosure is contemplated, most desirably, as a media structure of architectural value in its representation of harmony and interconnectedness that also has the utilitarian function of supporting digital display monitors that project content representing the same. However, within the scope of this invention, a corresponding media structure could possess no appreciable architectural value whatsoever, and corresponding monitors could project content entirely antithetical to promoting harmony or human connection. Therefore, what should be understood is that the common characteristics of various embodiments of the present invention are a media system structure featuring a display housing(s), one or more electronic visual displays (i.e., monitors and integral or connected speakers) that are positioned within each such housing so as to be viewable from a range of surrounding vantage points (preferably, viewable from a full 360-degree perimeter around the structure), and a support structure element that undergirds and elevates the display housing so that its monitors are also viewable from a distance.

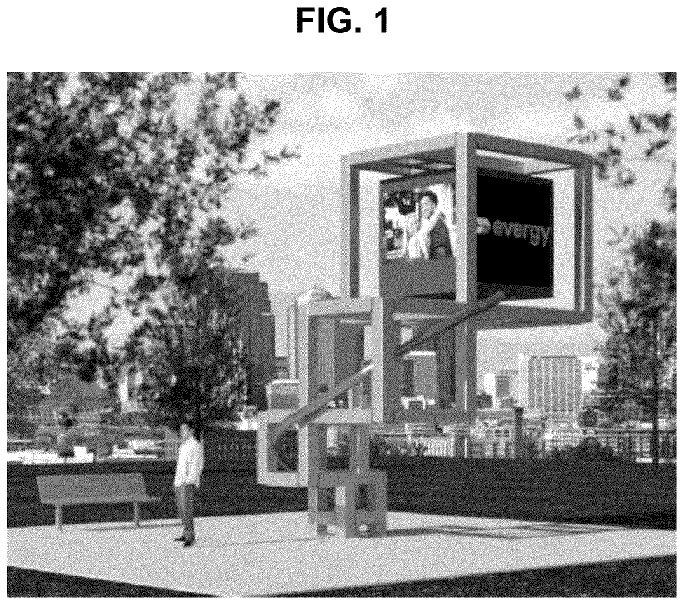

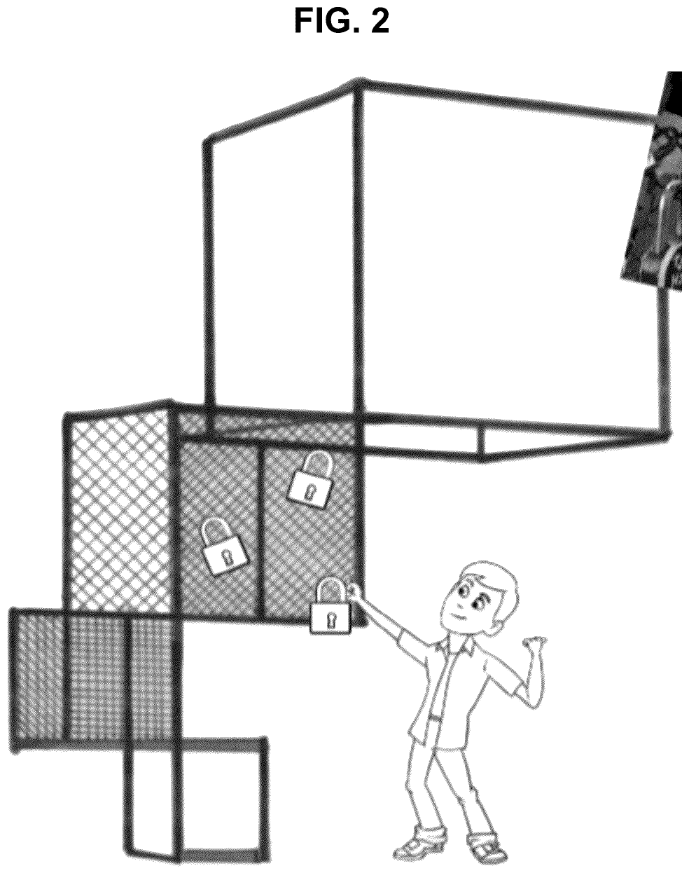

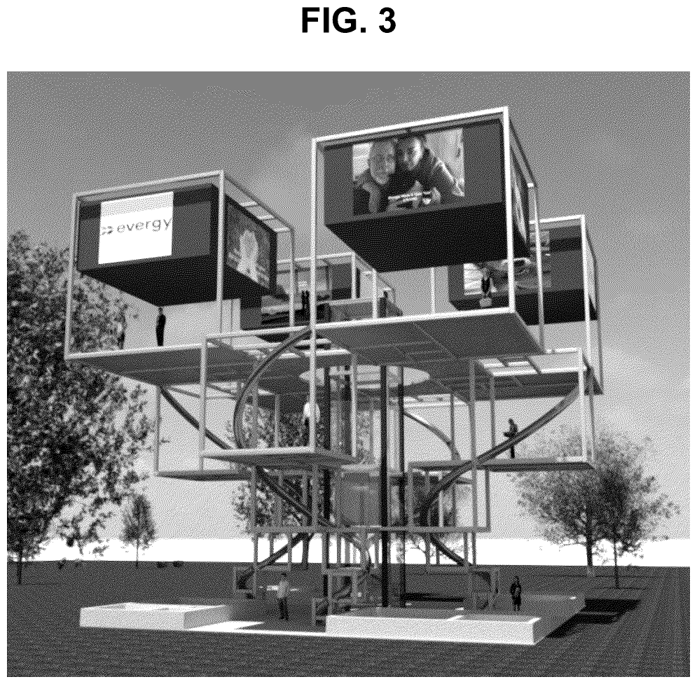

Accordingly, in a first embodiment of the invention depicted in FIG. 1, the vertical support structure 10 is, in fact, formed of a series of connected, cubical metal frames and an integrated curvilinear rod that are all arranged in Fibonacci spiral fashion. Fixed atop that assembly 10 is another cubical frame 20 that forms a housing for four display monitors 30 which are each facing perpendicular to the other two monitors 30 positioned immediately adjacent their respective right and left edges. In fact, multiple separate display housings that each possess separate monitors can be incorporated into the media structure as shown in FIG. 3. Additionally, as shown in the FIG. 2 depiction of the single display housing embodiment of the invention, built into at least one facing of at least one cube of the vertical support structure 10 is wire mesh 40 meant for structure site visitors to attach their personal love padlocks to.

Along with the structure is at least one receiver and a computer (neither shown) to form an operating media system. That is, the receiver receives media that prospective system users submit via the Internet or a private network using a web interface or a mobile app. That media can be in the form of submitted text messages, still images, or audiovisual files. And while the present inventor contemplates that the subject of this media should be in keeping with a theme of love or connectedness, that does not necessarily have to be so in every, or any, instance within the scope of the invention.

Nevertheless, upon the submitted media being received by the system's receiver, it is delivered to the computer for analysis. More specifically, applying its software logic, the computer determines: (1) which received media files should be permitted viewing on the displays 30; and (2) in what sequence that permissible media should be displayed. Upon the computer making those determinations, received media is transmitted to the monitors and speakers 30 for publication in accordance.

Another embodiment of the invention (not shown) necessarily differs from the aforedescribed embodiment in only one respect. That is, this embodiment further incorporates some number of residential dwellings (not shown) located proximate the media structure as part of an inventive ecosystem. To wit, livable dwelling structures surround the land space upon which the media structure is built such that the media structure becomes a focal point of a residential neighborhood, or at least of a sub-portion of a broader residential real estate development. For example, the dwellings can be architecturally designed and positioned so that there exist clear lines of sight between each dwelling patio (or even window) and one of the visual displays 30 perched within the media structure. This relative positioning allows dwelling occupants to enjoy content broadcasted on the displays 30 from the comfort of their own homes (or their yards, anyway).

Within the spirit of this concept, a wide variety of media content can be shown on the displays 30, but it is anticipated that more specialized content, such as exercise courses or cooking classes, will be scheduled for airing during certain time slots, while more broadly appealing content (e.g., movies) will be scheduled for other time slots. Regardless, the small community feature that is the present media structure encourages neighbors to enjoy programming together, rather than as they likely would otherwise: isolated from each other inside their respective homes. In that sense, this communal features stands to greatly build upon the virtue of familiar common use features like the neighborhood swimming pool.

Furthermore, while interaction between users and the media system of this embodiment can be similar to that described for the first embodiment above, in this embodiment, it is anticipated the residential dwellings will be equipped with transmitter devices that allow dwelling occupants to send their preferred media to the system to be played (maybe) on the community monitors 30. Those transmitters can be in the form of an input devices built into the homes and/or they could be in the form of mobile app accounts each assigned to persons associated with the dwellings (i.e., owners or tenants).

It is understood that substitutions and equivalents for various elements set forth above may be obvious to those skilled in the art and may not represent a departure from the spirit of the invention. Therefore, the full scope and definition of the present invention is to be set forth by the claims that follow.

What is claimed is:

1. A communal connecting media system comprising:
a support structure;
a display housing disposed atop the support structure;
at least one electronic visual display disposed within the display housing; and
mesh attached to the support structure, wherein the mesh is for securing padlocks to.

2. The communal connecting media system of claim 1, wherein said visual display(s) is viewable from substantially all around the periphery of said support structure.

3. The communal connecting media system of claim 1, wherein said support structure comprises connected cubical elements.

4. The communal connecting media system of claim 1, further comprising:
a receiver for receiving media content;
a computer in communication with the receiver and said visual display(s), wherein the computer is capable of:
(a) determining whether media content received by the receiver is displayable on said visual display(s) according to predetermined criteria for making that determination;
(b) determining a sequence for displaying displayable media content on said visual display(s) according to predetermined criteria for making that determination; and
(c) displaying displayable media content on said visual display(s) in that sequence.

5. A communal connecting media system comprising:
a support structure;
a display housing disposed atop the support structure;
at least one electronic visual display disposed within the display housing;
a receiver for receiving media content;
a computer in communication with the receiver and the visual display(s), wherein the computer is capable of:
(a) determining whether media content received by the receiver is displayable on the visual display(s) according to predetermined criteria for making that determination;
(b) determining a sequence for displaying displayable media content on the visual display(s) according to predetermined criteria for making that determination; and
(c) displaying displayable media content on the visual display(s) in that sequence;
a plurality of inhabitable dwellings disposed within the vicinity of the support structure, wherein each such dwelling has a designated user associated therewith; and
wherein each designated user is enabled to transmit media content to the receiver for potential display on the visual display(s).

6. The communal media system of claim 5, further comprising a media content transmitter disposed within each said dwelling, wherein each such transmitter is enabled to transmit media content to said receiver for potential display on said visual display(s).
